(19) United States
(12) Patent Application Publication
(10) Pub. No.: US 2008/0297719 A1
(43) Pub. Date: Dec. 4, 2008

(54) Glasses combined with sun/wind screens-II

(76) Inventor: Yong Chu K. Brillouet, Canyon Country, CA (US)

Correspondence Address: Eugene Oak, Ph.D., J.D., M.Div., 610 S. Van Ness Ave., Los Angeles, CA, 90005, US

(21) Appl. No.: 11/807,586

(22) Filed: May 30, 2007

(51) Int. Cl. G02C 11/00

(52) U.S. Cl. 351/158

(57) ABSTRACT

A glasses combined with retractable screens is provided. The glasses combined with retractable screens is comprised of a frame of glasses that has void space therein. Small spring re-winders are installed inside of both of legs of the glasses frame. Screens such as veil, scarf, satin, and gauze etc., are engaged to the re-winders. When a wearer is exposed to strong sun light or winds, the wearer drags small pulls, which are small metal hooks and attached at one end of the screen, out of the frame and fix it to proper means, such as tying it to other pulls that attached to other screen. The screens come out of lower face of the legs of the glasses frame to cover cheeks of the wearer and the screens come out of the upper face of the legs of the glasses frame to cover upper part of the face of the wearer including hair.

### FIELD OF THE INVENTION

Current application relates to a glasses combined with screens, especially relates to a glasses equipped with retractable screens to cover cheeks and upper part of face from strong sun light and winds.

### BACKGROUND OF THE INVENTION

When people go out side on a sunny day, many of them wear sun-glasses to protect their eyes from the strong sun light. However, conventional sun-glasses can shades only a small portion of the wearer's face around eyes. Therefore, long time exposure to strong sun light, such as playing golf, picnicking, and gardening, often leaves a tanned mark to face of the wearer. Such tanned marks are especially not desirable for ladies. Even though sun shade creams may fade out such tanned marks, it is not convenient to apply cream and wipe it out. Therefore, they usually wear sun visors or hats in addition to sun-glasses. But even sun visors can not protect wearer's face from ultra-violet rays that are reflected by the ground and air. The sun visor or hats is then covered with towel or scarf. That is extremely un-comfortable and odd in appearance. The sun visor or hat can also be blow away by the wind. It is the purpose of the current application to provide a more convenient means to protect wearer's eyes and face skin at the same time from the sun lights and wind simultaneously. The glasses combined with sun/wind screens not only protects wearer's face from strong sun lights but also keeps the hair from getting tangled by the wind.

### DESCRIPTION OF THE PRIOR ART

U.S. Pat. No. 5,956,119 to Gibbs illustrates a positionable face mask support for attaching to a pair of glasses. The positionable face mask support is adaptable to be used with any pair of glasses for protecting individuals who work with bodily fluids of humans or animals from direct contact with such fluids. The positionable face mask support comprises attachments, releasable latching members and biasing means for attaching to the face mask and allowing the face mask to be positioned in one of a plurality of positions ranging from being against a wearer's face to being substantially lifted away from the wearer's face. The mask support further comprises flexible members depending there from for attaching to cheek portions of the face mask and for conforming to the wearer's face.

U.S. Pat. No. 5,278,999 to Brown, et al. illustrates an improved combined ear and eye protector is disclosed which provides optimum flexibility by permitting the use of both eye and ear protection, or alternatively eye protection only or ear protection only. Maximum flexibility is achieved by providing an ear protection system which includes a head support independent of the eye protector.

U.S. Pat. No. 4,944,039 to Dietrich illustrates a protective face mask attachable to glasses. The mask comprises a thin frame generally formed to cross transversely over the bridge of the nose, below the eyes and across the cheeks of the user; a protective cover attached to the frame and extending freely there from to hang in front of the nose and mouth of the user; and attachment hooks for attaching the frame to the glasses.

U.S. Pat. No. 4,843,643 to Parissenti, et al. illustrates a protective visor, particularly for dentists, composed of a shield supported by a supporting element having bar elements connectable to the rods of a pair of spectacles or the like.

U.S. Pat. No. 4,821,340 to Johnson illustrates a face shield to protect an individual against inhaling germs and other foreign bodies comprising a permanent clip portion which is adapted to be mounted on the nose piece of a pair of eyeglasses and a disposable sheet of relatively thin rigid plastic which is remove-ably attached to the clip. This enables the sheet to be removed and discarded after a single use and replaced by an identical sheet prior to treatment of a new patient.

U.S. Pat. No. 3,991,753 to Viescay Viesca illustrates a device for preventing an individual from inhaling germs, foreign bodies, and the like. The device includes only a single sheet of a relatively light-weight plastic material which has an outer convex surface area and an opposed inner concave surface area defining for the sheet a hollow interior space adapted to receive the nose, mouth, and chin of an individual, with the sheet having connected thereto a structure for mounting the sheet on the head of the individual in such a way that while the nose, mouth, and chin of the individual are in the hollow interior of the sheet nevertheless the nose, mouth, and chin do not engage the inner surface area of the sheet.

U.S. Pat. No. 3,298,032 to Sielisch illustrates a snap-on lift front lens that is mounted on a frame of glasses. The snap-on lens is a sheet of lens that is pivotally mounted on a frame of glasses by a spring wire. The sheet type lens is larger than the frame of the glasses and may cover some part of face of wearer.

U.S. Pat. No. 3,298,031 to Morgan illustrates a safety face mask. The mask is separably connected to a goggle to cover the lower part and upper part of the face of a wearer.

None of the prior art illustrates a retractable face shield that comes out of the legs of a glasses to shade the face of a wearer when the sun is too hot or wind is strong to protect the wearer's face.

### SUMMARY OF THE INVENTION

When people go out side on a sunny day, many of them wear sun-glasses to protect their eyes from the strong sun light. However, conventional sun-glasses can shades only small portion of the wearers face around eyes. Therefore, long time exposure to strong sun light, such as playing golf, picnicking, and gardening, often leaves a tanned mark to the face of the wearer. Even though sun shade creams may fade out tanned marks, it is not convenient to apply cream and wipe it out. Such marks are especially not desirable for ladies. Therefore, they usually wear sun visors or hats in addition to sun-glasses. But even sun visors can not protect wearer's face from ultra-violet rays that are reflected by the ground and air. The sun visor or hat is then covered with a towel or scarf. This is extremely uncomfortable and odd in appearance. The sun visor or hat can also be blown away by the wind. It is the purpose of the current application to provide a more convenient means to protect wearer's eye and face skin from the sun light and wind simultaneously. The glasses combined with sun/wind screens according to current application not only protects wearer's face from the strong sun lights but also keeps the hair from getting tangled by the wind. The glasses combined with retractable screens is comprised of a frame of glasses that has void space therein. Small spring re-winders are installed inside of both of legs of the glasses frame. Screens such as veil, scarf, satin, and gauze etc., are engaged to the re-winders. When the wearer is exposed to strong sun light or winds, small pulls which are small metal hooks and attached at one end of the screen, can be dragged out of the frame and fix it to proper means, such as tying them to other pulls. Screens come out of lower face of the legs of the glasses frame to cover cheeks of the wearer and the screens come out of the upper face of the legs of the glasses frame to cover upper part of the face of the wearer including hair.

### BRIEF DESCRIPTION OF DRAWINGS

FIG. 1 is a perspective view of a glasses combined with sun/wind screens according to current application, when the screens are retracted inside of frame of the glasses.

FIG. 2 is a perspective view of the glasses combined with sun/wind screens according to current application, when the screens are deployed outside of the glasses.

FIG. 3 is a perspective view of the glasses combined with sun/wind screens according to current application worn by a wearer and the screens are deployed to cover face and head of the wearer.

FIG. 4 is an over view of the glasses combined with sun/wind screens according to current application, when the hair covering screens is retracted inside of the glasses.

FIG. 5 is a bottom view of the glasses combined with sun/wind screens according to current application, when the screens are retracted inside of the glasses.

FIG. 6 is an exploded view of leg of the glasses combined with sun/wind screens according to current application, showing rewinding and deploying system installed inside of the leg thereof.

FIG. 7 is an enlarged cross-sectional view of rewind and deploying system seen along the line A-A′ in FIG. 5.

FIG. 8 is an enlarged cross-sectional view of rewind and deploying system seen along the line B-B′ in FIG. 5.

### DETAILED DESCRIPTION OF THE PREFERRED EMBODIMENT

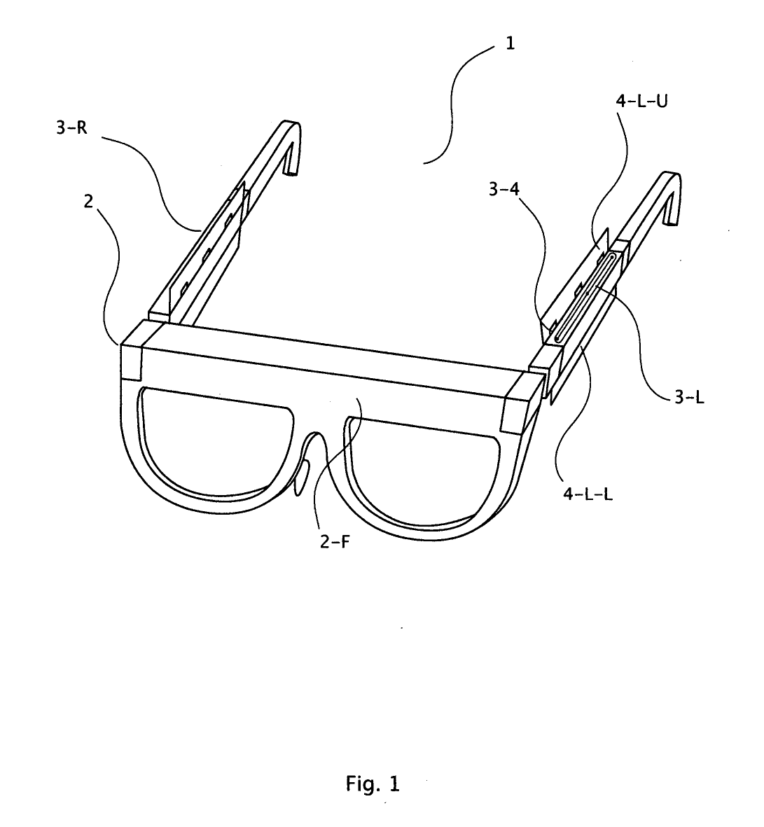

FIG. 1 is a perspective view of glasses (1) combined with sun/wind screens according to current application, when the screens are retracted inside of frame (2) of the glasses. Appearance of the glasses (1) according to current application is almost same as conventional glasses. The glasses (1) has front frame (2-F) and leg frames (3-L) and (3-R).

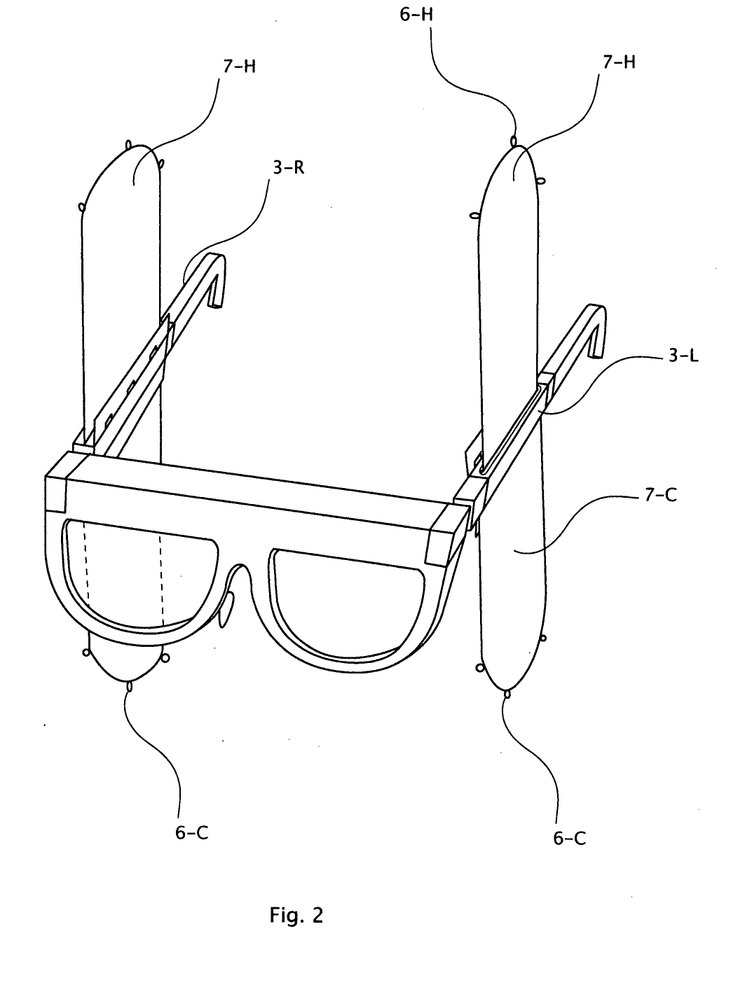

FIG. 2 is a perspective view of the glasses (1) combined with sun/wind screens (7) according to current application, when the sun/wind screens (7) are deployed outside of the frame (2) of the glasses (1). Hair covering screens (7-H) come out of the upper face of the leg frames (3-L), (3-R). The hair covering screen (7-H) may be a resilient gauze, scarf, satin, and veil, etc. Various kinds of drawings, logos, trademarks can be printed thereon for decoration. Wearers fix hair pulls (6-H), which are small metal hooks and attached on one end of the hair covering screen (7-H), to their hair with hair pins or tying them each other. Cheek covering screens (7-C) come out of lower surface of the leg frames (3-L), (3-R). The cheek covering screens (7-C) may be resilient gauze, scarf, satin, and veil, etc. Various kinds of drawings, logos, trademarks can be printed thereon for decoration.

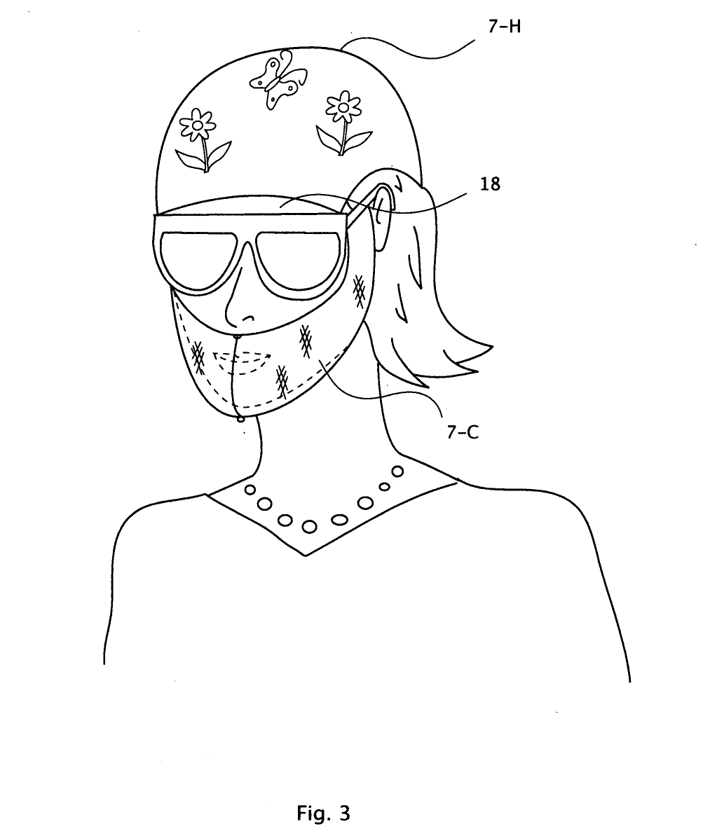

FIG. 3 is a perspective view of the glasses (1) combined with sun/wind screens according to current application worn by a wearer and the screens are deployed to cover face and head of the wearer. When a wearer put on the glasses (I) according to current application, deploy the hair covering screen (7-H) and fix it to his/her hair, a gap (18) is developed on fore head of the wearer due to the resiliency of the screen. Then the appearance of the wearer's head looks like wearing a scarf. The hair covering screen (7-H) not only shades the sun light but also protects the wearer's hair from tangled. The cheek covering screens (7-C) are fixed by tying cheek pulls (6-C), which are small metal hooks, each other that are attached on the opposite cheek covering screen. User can cover desired part of his/her lower front face by pulling the cheek covering screens (7-C) up-ward because of the resiliency of the composing material. The cheek covering screens (7-C) not only shades the sun light but also protect the wearer's skin from dry up by the wind.

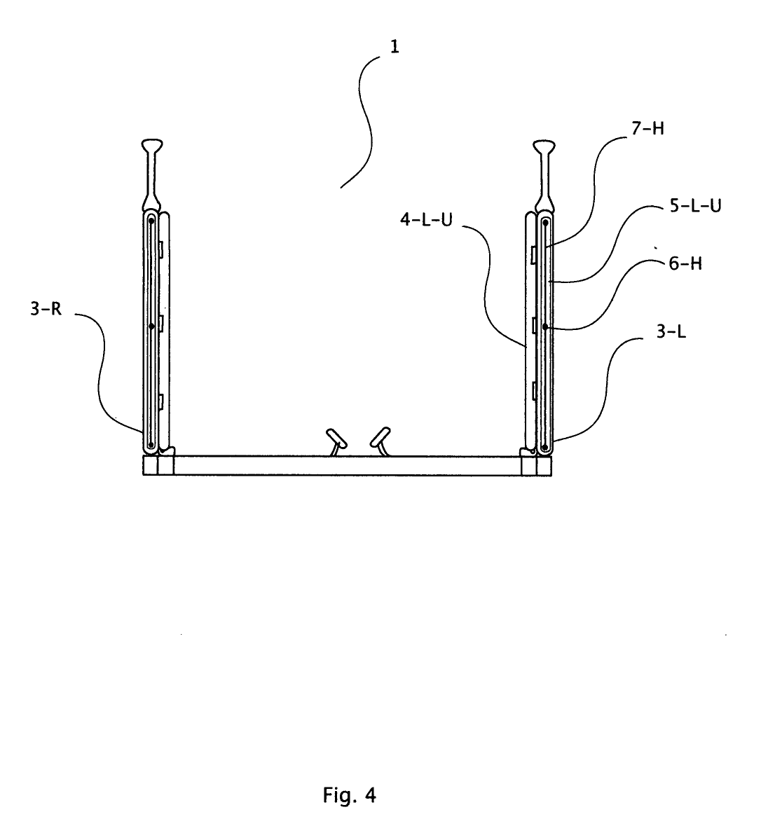

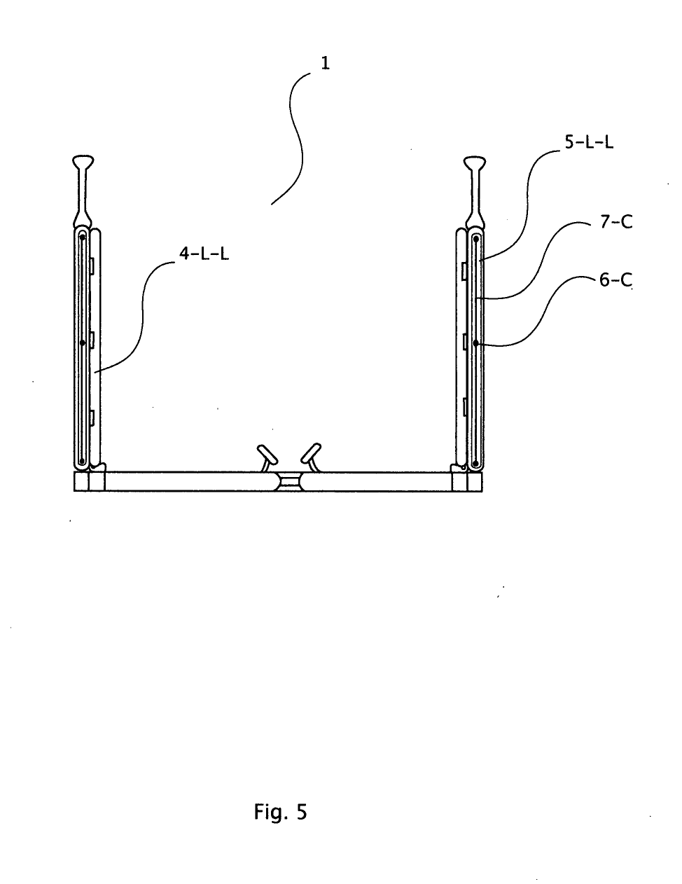

FIG. 4 is an over view of the glasses combined with sun/wind screens according to current application, when the hair covering screens (7-H) is retracted inside of the glasses and FIG. 5 is a bottom view of the glasses (1) combined with sun/wind screens of current application, when the cheek covering screens (7-C) are retracted inside of the glasses.

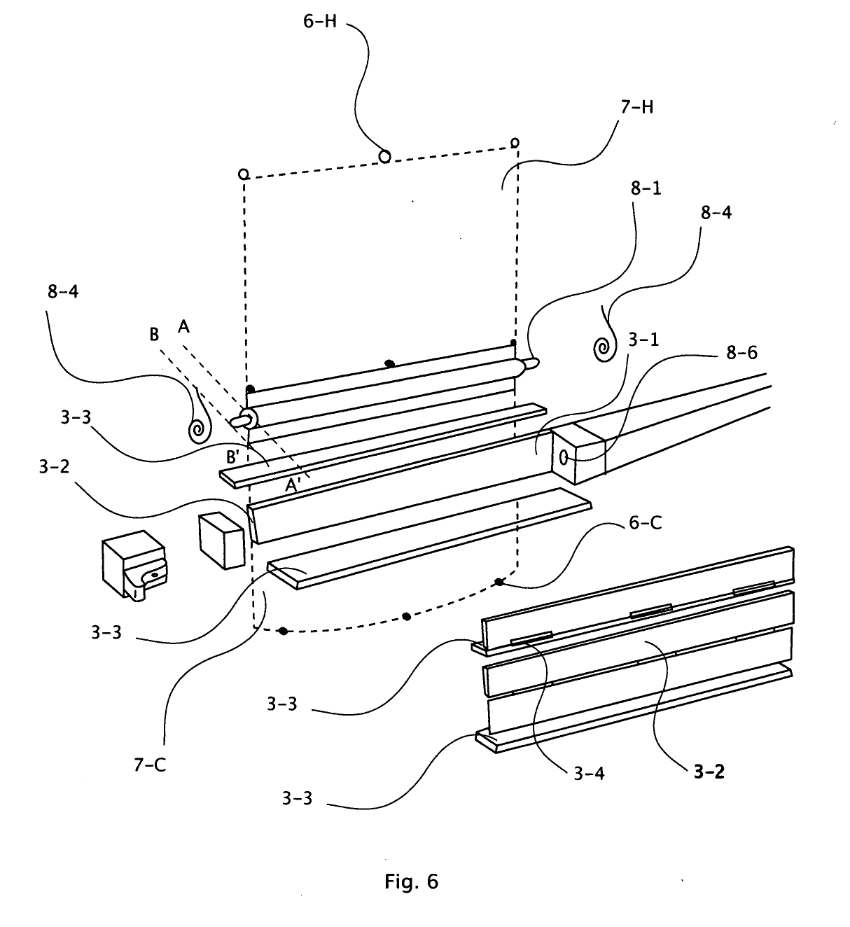

FIG. 6 is an exploded view of leg (3) of the glasses (1) combined with sun/wind screens according to current application, showing rewinding and deploying system (8) installed inside of the leg frames (3-L) and (3-R) thereof. The leg frames (3-L), (3-R) have a void space (3-1) that is formed by assembling two broad side plates (3-2) and four narrow plates (3-3). Among the four narrow plates (3-3), two narrow plates (3-3) are placed on the lower part of each leg frame (3-L), (3-R) to form a lower leg slit (5-L-L) through which the cheek covering screens (7-C) come in and out of the leg frames (3-L), (3-R). Another two narrow plates (3-3) are placed on the upper part of each leg frame (3-L), (3-R) to form an upper leg slit (5-L-U) through which the hair covering screens (7-H) come in and out of the leg frames (3-L), (3-R).

The rewinding and deploying system (8) is comprised of one center shaft (8-1), to which the cheek covering screen (7-C) and the hair covering screen (7-H) are firmly attached, one hollow tube (8-2) that has two long slits of lower slit (8-3-L), and upper slit (8-3-U) along the length thereof. The cheek covering screen (7-C) comes out through the lower slit (8-3-L) and hair covering screen comes out through the upper slit (8-3-U). Two swirled ribbon springs (8-4) that are installed on both ends of the center shaft (8-1).

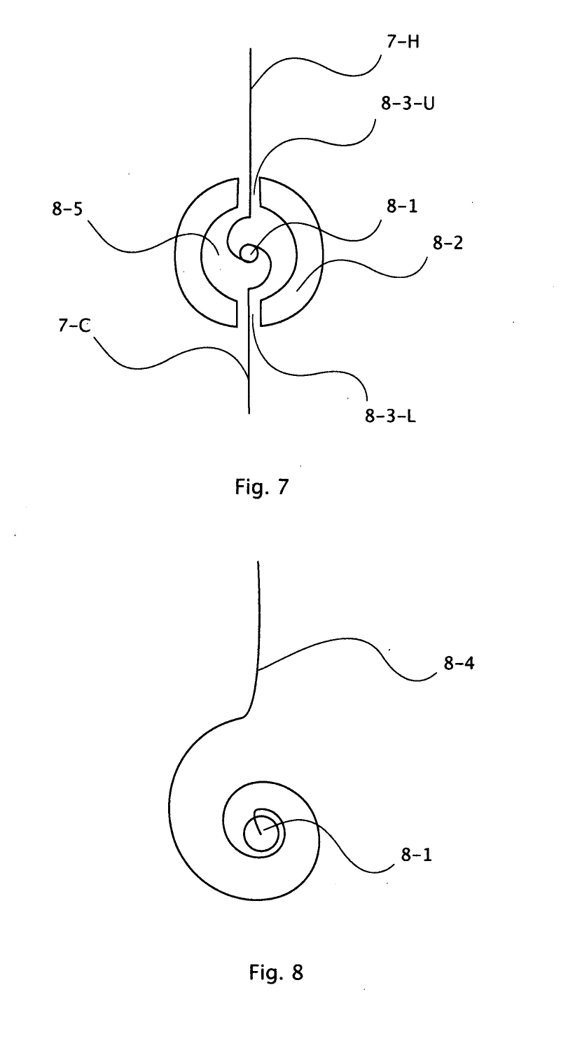

FIG. 7 is an enlarged cross-sectional view of rewind and deploying system (8) seen along the line A-A′ in FIG. 6. And FIG. 8 is an enlarged cross-sectional view of rewind and deploying system (8) seen along the line B-B′ in FIG. 6. A space (8-5) is developed between the center shaft (8-1) and the hollow tube (8-2) to receive the wound cheek covering screen (7-C) and the hair covering screen (7-H). One swirled ribbon spring (8-4) on one end of the center shaft (8-1) are engaged to a hole (8-6) that is developed inside of one narrow end of the space (3-1). Other swirled ribbon spring (8-4) on other end of the center shaft (8-1) are engaged to a hole (8-6) that is developed inside of other narrow end of the space (3-1). The leg slits (5-L-L), (5-L-U) and pulls (6-C), (6-H) are covered with solid leg covers (4-L-U), (4-L-L). The solid leg covers (4-L-U) and (4-L-L) are rotate-ably attached to one of the two broad side plates (3-2), which faces the wearer's face, via three hinges (3-4).

What is claimed is:

1. A glasses combined with sun/wind screens comprises of:
a front frame, and
two leg frames of a left leg frame and a right leg frame, each of them has a void space that is formed by assembling two broad plates and four narrow plates, two of the narrow plates are placed on the lower face of one leg frame to form a lower leg slit through which one cheek covering screen comes in and out thereof and another two narrow plates are placed on the upper face of the leg frame to form an upper leg slit through which a hair covering screen comes in and out thereof, and
four solid leg covers, each of them covers a leg slit and three small cheek pulls, and
twelve hinges, three of them rotatably attach one of the solid leg cover to upper face of the left leg frame and another three of them rotatably attach one of the solid leg cover to lower face of the left leg frame and the other three of them rotatably attach one of the solid leg cover to upper face of the right leg frame and the last three of them rotatably attach one of the solid leg cover to lower face of the right leg frame, and
two hair covering screens, each of them comes out of the upper face of each of the leg frames, and
two cheek covering screens, each of them comes out of the lower face of each of the leg frames, and
six small head pulls, which are small metal hooks and each three of them are attached on one end of one hair covering screen, and
six small cheek pulls, which are small metal hooks and each three of them are attached one end of one cheek covering screen, and
two screen rewinding and deploying systems, each of which is installed inside of the leg frames and comprised of;
one center shaft, to which one cheek covering screen and one hair covering screen are firmly attached, and
one hollow tube that has one upper slit and one lower slit along the length thereof; through the upper slit the hair covering screen comes in and out and through the lower slit the cheek covering screen comes in and out, and
two swirled ribbon springs that are installed on both ends of the center shaft and one of the swirled ribbon spring that locates on one end of the center shaft is engaged to a hole that is developed inside of one narrow end of the space and the other swirled ribbon spring located on the other end of the center shaft is engaged to another hole that is developed inside of other narrow end of the space.

2. A glasses combined with sun/wind screens of claim 1, wherein the hair covering screen is made of gauze.

3. A glasses combined with sun/wind screens of claim 1, wherein the hair covering screen is made of satin.

4. A glasses combined with sun/wind screens of claim 1, wherein the hair covering screen is made of veil.

5. A glasses combined with sun/wind screens of claim 1, wherein the cheek covering screen is made of gauze.

6. A glasses combined with sun/wind screens of claim 1, wherein the cheek covering screen is made of satin.

7. A glasses combined with sun/wind screens of claim 1, wherein the cheek covering screen is made of veil.
